(19) United States
(12) Patent Application Publication
(10) Pub. No.: US 2004/0218387 A1
(43) Pub. Date: Nov. 4, 2004

(54) LED lighting arrays, fixtures and systems and method for determining human color perception

(76) Inventor: Robert Gerlach, West Jordan, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/804,463

(22) Filed: Mar. 18, 2004

Related U.S. Application Data
(60) Provisional application No. 60/455,896, filed on Mar. 18, 2003.

(51) Int. Cl. F21V 9/00

(52) U.S. Cl. 362/231; 362/240

(57) ABSTRACT

LED arrays and light fixtures are disclosed wherein the discrete LEDs in the array emit light at one of multiple dominant wavelengths corresponding to at least five different colors within the visible spectrum. Systems based on the LED arrays and light fixtures are also disclosed. Additionally, a method of testing human visual perception is also disclosed.

### CROSS-REFERENCE TO RELATED APPLICATIONS

This utility patent application claims priority to U.S. provisional patent application Ser. No. 60/455,896, filed Mar. 18, 2003.

### BACKGROUND OF THE INVENTION

1. Field of the Invention

The present invention relates generally to electrical lighting fixtures. More particularly, this invention relates to lighting fixtures containing multiple distinct light-emitting devices or groups of devices, e.g., light emitting diodes (LEDs) and systems for additively mixing colors of light and a method of determining human color perception.

2. Description of Related Art

Light sources are varied and well known in the art. Light sources are commonly used to illuminate objects or rooms in the absence of natural light sources. Thus, light sources are very common inside buildings. One application for a light source is theatrical or stage lighting to artificially produce white and colored light for illumination and special effects.

Many conventional light sources produce wavelengths across a relatively broad portion of the visible spectrum of light, for example, incandescent, fluorescent and many high-intensity discharge (HID) lamps. Such light sources may be referred to as white light sources. Other light sources may cover a relatively narrow band of the visible spectrum. Examples of such narrowband light sources include LEDs and lasers, which inherently exhibit a color associated with the dominant wavelength of their spectral power distribution.

Conventional theatrical lighting fixtures typically utilize a lamp that radiates white light, which is then filtered in various ways to produce color when colored light is desired. Filtering subtracts certain wavelengths from a beam with a broad spectral power distribution. For example, the conventional “PAR” fixture includes a white light source (lamp) with a parabolic reflector directing light to a lens with gel color filters and typically housed in a cylindrical or can configuration. Conventional theatrical lighting fixtures may be automated with motors that are attached to lenses or to rolls of flexible gels (filters) that move in front of the lamp. Occasionally some fixtures are fitted with multiple, overlapping rolls of gels or colored lenses. When such filters are used in combination, this is known as subtractive color mixing and provides a limited range of automated color control. On most fixtures, however, filters are fixed and must be changed manually to alter the color. Manual filter changing can be an expensive and time-consuming process.

It is also well known to combine the light of two different colors to obtain a third color. This is known as additive color mixing. Conventionally, the three most commonly used primary colors—red, green and blue (RGB)—are combined in different proportions to generate a beam that is similar in appearance to many colors across the visible spectrum. Conventional LED lighting fixtures and systems use various combinations of LEDs outputting the primary RGB colors to obtain a desired color of light. There are fixture manufacturers today who utilize a mix of red, green, and blue LEDs to produce color. Typical of such conventional systems are those disclosed in U.S. Pat. Nos. 6,016,038, 6,166,496 and 6,459,919 all to Lys et al. Other conventional LED lighting systems incorporate an additional color, amber, often with the intent of providing means of altering the correlated color temperature (CCT) when the mix of red, green, and blue LEDs is adjusted to produce white light. The general advantages of using LEDs as the basis for lighting fixtures are commonly known by those familiar with the technology in the illumination industry.

A common misunderstanding of human color perception holds that since we distinguish color by using three different kinds of receptor cones in our eyes (a widely understood and proven physiological fact) we therefore perceive only three primary colors of light. The thinking continues toward the belief that by using a mix of three primary colors of light in various relative intensities, we can precisely duplicate any color in the spectrum.

This conventional, though limited, understanding of human color perception is inaccurate. If it were true that the human eye can only respond to three colors of light, one would be unable to view a rainbow. Instead of a broad wash of graduated colors, one would see only three, very narrow lines of light. One might experience relatively little light radiating from many artificial light sources, such as neon tubes and low- and high-pressure vapor lamps, which produce discrete wavelengths of color that are often not red, green, or blue. The perceived light from other artificial sources would be greatly reduced, since fluorescent tubes (and many other lamps) produce a series of irregular spikes of color along the spectral range, rather than an even mix of all wavelengths.

Other common misunderstandings include the following: the combination of red, green, and blue light is equivalent to “full-spectrum” light; red, green and blue combined in the right proportions can produce true, white light at any CCT that appears and illuminates colored objects in the same way as a real full-spectrum source like midday sunlight; an increase or decrease in amber light alone is sufficient to alter the CCT of a white-light mix across a broad range of CCT values.

LED-based lighting fixtures that implement any of these misconceptions produce light that is inadequate for a broad range of effective, primary illumination. RGB fixtures produce colored light with relatively poor saturation across the spectrum, except at red, green, and blue. RGB fixtures illuminate colored objects in an unnatural way, making many colors appear hyper-real or more vivid than under midday sunlight but also making them appear less differentiated from one another, with a strong tendency to make colored objects appear either more red, more green, or more blue than normal. RGB fixtures exhibit relative luminance levels that are difficult for an average user to predict when mixing colors because they do not correlate with the relative luminance levels of conventional lamps with filters of similar colors. White light from RGB fixtures appears weak, empty, or grayish to many observers. RGB fixtures often produce an undesirable response on human skin tones, making many flesh colors appear ruddy or slightly greenish or grayish. RGB fixtures have a limited range of CCT values that appear rich, full, and satisfying to the average observer.

The addition of amber to an RGB fixture (RGBA) for the purpose of “color correcting” or lowering the CCT of its white light often results in light that appears unnaturally pinkish. Most such four-color, RGBA, lighting systems do not contain amber LEDs that together produce a high enough level of relative luminance to significantly add to color-mixing capabilities or to alter the undesirable rendering of colored objects and skin tones.

Prior art by Cunningham, U.S. Pat. No. 6,683,423, describes a lighting apparatus having groups of distinct light-emitting devices, e.g. LEDs, that can be controlled to produce a beam of light having a spectrum that closely emulates that of any one of a number of conventional light sources, e.g. an incandescent bulb, and that has a normalized mean deviation (NMD) across the visible spectrum, relative to that of the beam of light being emulated, of less than about 30%.

There are flaws in the approach taken by Cunningham to describe the output of the claimed invention. The standard of 30% or less NMD does not correlate with the human eye response. The invention could achieve 30% NMD—or even much less—and still produce a light beam that behaves differently on illuminated objects and that appears very different to the average human observer than the one being emulated. Cunningham provides no metrics for relating the output of this invention to the response of an average human observer, which is the most critical component of measurement when describing an apparatus suitable for use as part of a lighting fixture. Without such metrics the invention is too broadly defined to be of real value.

For example, if the invention produces a spectral distribution curve that is slightly above the reference at wavelengths shorter than 550 and slightly below the reference at wavelengths longer than 550, the composite beam would have a much more dominant blue component than the one being emulated, although the NMD for the entire spectrum might be well within 30%. Not only would this make the beam itself have a different apparent color or whiteness, it would alter the way the beam illuminates colored objects, perhaps drastically.

In another example, if the majority of the spectrum of the invention is closely related to the spectrum of the reference source, the invention could completely omit a portion of the spectrum—a gap perhaps as large as 70 to 80 nm wide-and still have a normalized mean deviation that is relatively low. Again, this could produce drastic apparent differences to the average human observer, both in beam color or whiteness and in the illumination of colored objects.

In a third example, the Cunningham invention could produce a spectrum that was nearly identical to the reference in all but a very narrow range of wavelengths—perhaps a range only 5 nm wide. In that 5-nm range, the invention could produce a huge spike in spectral output, equivalent to the addition of a very bright, deeply saturated colored light, and still produce an NMD for the whole spectrum that is well under 30%. Obviously, the resulting light would look nothing like the reference, nor would it illuminate colored objects in the same way.

Accordingly, there exists a need in the art for LED arrays, lighting fixtures and systems that not only include LEDs emitting conventional RGB or RGBA colors, but that emit other colors as well. There also exists a need to define these inventions by parameters that are based on the human visual response, in order to provide a more certain guarantee that the inventions produce light that is desirable for a broad range of applications. Such LED arrays would overcome the inherent limitations of all known lighting fixtures that include multiple colors of LEDs.

### BRIEF SUMMARY OF THE INVENTION

Embodiments of the invention include LED arrays, and light fixtures wherein the discrete LEDs in the array emit light at one of multiple dominant wavelengths corresponding to at least five different colors within the visible spectrum. Systems based on the LED arrays and light fixtures are also disclosed. Additionally, a method of testing human visual perception is also disclosed.

Additional features and advantages of the invention will be apparent from the detailed description which follows, taken in conjunction with the accompanying drawings, which together illustrate, by way of example, features of embodiments of the present invention.

### BRIEF DESCRIPTION OF THE SEVERAL VIEWS OF THE DRAWINGS

The following drawings illustrate exemplary embodiments for carrying out the invention. Like reference numerals refer to like parts in different views or embodiments of the present invention in the drawings.

FIG. 1 is a block diagram of a LED lighting system in accordance with an embodiment of the present invention.

FIG. 2 illustrates a two-dimensional layout of an embodiment of a LED array consistent with the present invention.

FIG. 3 is a graph of the spectrum of a 7-Color LED array at full power in accordance with an embodiment of the present invention.

FIG. 4 is a graph of the spectrum of a 7-Color LED array at white in accordance with an embodiment of the present invention.

FIG. 5 is a graph of the spectrum of an 8-Color LED array in accordance with an embodiment of the present invention.

FIG. 6 is a graph of the spectrum of a 10-Color LED array in accordance with an embodiment of the present invention.

FIG. 7 is a graph of the spectrum of a 12-Color LED array in accordance with an embodiment of the present invention.

FIG. 8 is a flow chart of a method for determining human color perception in accordance with the present invention.

FIG. 9 is a graph of the spectrum of a conventional RGB LED array.

### DETAILED DESCRIPTION OF THE INVENTION

Embodiments of the present invention include LED arrays, fixtures and systems utilizing LEDs radiating light in at least five different dominant wavelengths within the visible spectrum. Another embodiment of the present invention includes a method for determining human color perception. The LED arrays, fixtures and systems of the present invention may be used in any application requiring lighting ranging from mere illumination to vivid and accurate production of multiple varieties of colored and white light. One such application is in the field of theatrical lighting. Of course, one skilled in the art will recognize that the potential applications for the LED arrays, fixtures and systems of the present invention are almost limitless. LEDs suitable for embodiments of the present invention may be of any type consistent with the requirements and limitations described herein, e.g., silicon-based LED, organic LED (OLED) and polymer LED (PLED) technologies.

The distinction between the understanding that there are three kinds of color receptors (cones) in the eye and the inaccurate notion that there are only three colors of perceived light is a critical one. The human visual system is a very complex network of receptors, transmitters, and signal processors that work in conjunction with one another. Many aspects of the physical and mental processes involved in color and white-light perception remain substantially unknown to science. Current consensus within the scientific community states that color perception is a complex interaction of both positive and negative stimuli within the visual network.

It is conventionally known that there are three different kinds of receptor cones in the human eye for stimulation by specific ranges of wavelengths of light. Every wavelength of light has the potential of stimulating each of these cones at a certain level of probability. The three cone types peak in the probability that they will be stimulated at points on the visible spectrum that are roughly equal to blue-violet, green, and yellow and are identified as short, medium, and long (S, M, and L) respectively. All three are necessary for robust color sensation across the visible spectrum. For example, a 420 nm wavelength of light has a very high probability of stimulating the S-cones in the eye, but only a low probability of stimulating the M-cones, and a very low probability of stimulating the L-cones. This is why a human observer can distinguish it as violet light, because the S-cones in the eye are the most stimulated by it and are therefore sending the strongest signals to the brain.

A 650 nm wavelength of light has a higher probability of stimulating the L-cones than stimulating the M-cones, much higher than stimulating the S-cones. It is of no consequence that there are no cones in the eye that peak in their sensitivity at that particular wavelength of light. What matters is that one type of cone is more sensitive to it than the other two. This is enough for the visual network to identify the light as red. This is the same for all colors of light, i.e., that the sensitivities of the three cone types peak at certain wavelengths is not nearly as important as the fact that all three peak in different places along the visible spectrum and that the sensitivity slopes gradually downward on either side of the peaks, rather than dropping off sharply to zero.

The level of saturation of a colored light is determined by the three cones working simultaneously. If there were only two cone types, it would be possible to achieve the same relative levels of stimulation of each while using different combinations of wavelengths. For example, a 590 nm amber wavelength will stimulate the L-cones at a high probability. It will stimulate the M-cones at a moderate probability. This same combination of high stimulation of the L-cones and moderate stimulation of the M-cones could be achieved by using a 650 nm red wavelength and a 530 nm green wavelength at the same time. By varying the intensities of each color, the stimulation levels could theoretically be balanced to exactly imitate the levels caused by the 590 nm light. Two cones working alone would not allow for clear and consistent distinction between a pure wavelength and a combination of two or more that approximate the appearance of the first.

However, there are three cone types in the eye: S-, M-, and L-cones. Thus, the mix of red and green wavelengths that produces the same levels of stimulation from the M- and L-cones as does amber light stimulates the S-cones differently. Amber light stimulates S-cones at a very low probability, almost zero. Green light, on the other hand, stimulates the S-cones with a slightly higher probability. This suggests that the red+green combination will appear less saturated than the pure amber light to an average observer.

It is the existence of these three kinds of cones in the eye, as well as the other receptors and processors within the human visual system (that may or may not be fully understood at this time) that teaches away from the concept of so-called “primary colors” that are capable of reproducing any other color within the visible spectrum at any given level of saturation. Every individual wavelength along the entire visible spectrum can be clearly identified and distinguished with relative precision from a substitute that mixes different wavelengths in combination to achieve its approximation. This is why RGB additive color mixing can only produce less saturated substitutions for most colors that are substantially different than red, green, and blue.

LEDs generally have a narrow spectral half-width, which means that they produce light in very saturated colors. To obtain white light from LEDs according to principles and embodiments of the present invention, multiple colors may be placed side by side and their light mixed together within the fixture. Colored light will be produced by turning on only certain LEDs or by reducing the relative luminance of certain LEDs. Ideally, a full spectrum of LEDs emitting dominant wavelengths of light completely across the visible spectrum can be obtained. However, as of this writing, some dominant wavelengths, such as 555 nm lime-yellow, are not available in commercially viable quantities in packages that produce relative luminance levels consistent with the brightest available LEDs. By varying the intensity of the nearest available colors, e.g., 530 nm green and 590 nm amber in the place of 555 nm lime-yellow, a substitution for these missing colors may be achieved according to embodiments of the present invention.

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

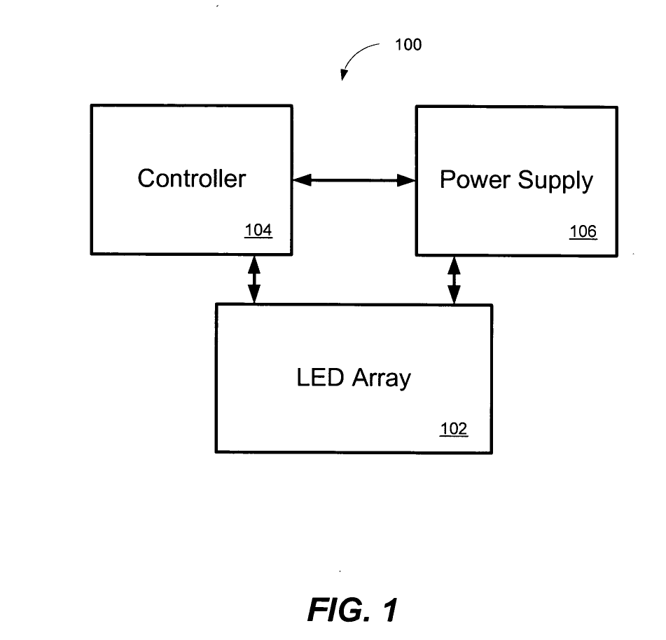

FIG. 1 is a block diagram of a LED lighting system 100 in accordance with the present invention. LED lighting system 100 may consist of only a LED array 102, or it may include a LED array 102 and a controller 104. LED lighting system may include a power supply 106 or alternatively be configured to connect to an external power supply 106. According to an embodiment of the present invention, controller 104 may independently drive any number of colors of LEDs. According to another embodiment, controller 104 may independently drive each LED in the LED array 102. Circuitry for implementing controller 104 and assembling a LED array 102 are within the knowledge of one skilled in the art having possession of this disclosure and, thus, will not be further elaborated on herein.

An embodiment of a LED array according to the present invention may be defined by plotting the output of each LED on a CIE Chromaticity diagram and connecting the points to create a region that encloses a percentage of the total area within the curve of spectrally pure colors and the straight line representing the purple colors, known as the alychne. There are a number of CIE Chromaticity diagrams suitable for this embodiment of a LED array. For example and not by way of limitation, the 1931 CIE Chromaticity Diagram for a 2-degree field and the 1976 CIE L′u′v′ Diagram are both suitable CIE diagrams according to embodiments of the present invention. The percentage of the total area enclosed by the plot of dominant wavelengths on the CIE Chromaticity diagram may be any suitable fraction of 100%. For example, the percentage of the total area enclosed by the plot of dominant wavelengths on the CIE Chromaticity diagram may be at least 75%, 85%, or even 95% of the total area according to embodiments of the present invention.

Another embodiment of a LED array according to the present invention may include relative luminance values for all LEDs within the LED array operating at full brightness levels resulting in a composite white-type light that may be plotted on a CIE Chromaticity diagram within McAdam ellipses that are on or adjacent to the Planckian Locus (which defines the region of color temperatures produced by a black-body radiator) within a predefined correlated color temperature (CCT) range. The predefined CCT range may be about 1500° K and about 25,000° K according to an embodiment of the present invention. The predefined CCT range may be about 3000° K and about 10,000° K according to another embodiment of the present invention. In still another embodiment of the present invention the predefined CCT range may be about 4500° K and about 7500° K. In yet another embodiment of the present invention, the predefined CCT range may be 5500° K and about 6500° K. Of course, other suitable predefined CCT ranges are also considered within the scope of the present invention. In still another embodiment of a LED array according to the present invention the relative luminance of each LED or group of LEDs in the LED array may comprise a spectral power distribution within 30% normalized mean deviation of a spectral power distribution of midday sunlight having correlated color temperature (CCT) of about 6500° K.

Yet another LED array according to the present invention may include a relative luminance of each LED or group of LEDs in the LED array that is consistent with the distribution of spectral power in midday sunlight (at a CCT of approximately 6500° K) in order to facilitate additive color mixing that produces intuitive intensity levels. It is understood that Luxeon brand LEDs by Lumileds, LLC, or any similarly bright LEDs from various manufacturers, may not be available in commercially viable quantities in all desired dominant wavelengths across the visible spectrum. Therefore, LEDs that are available in the dominant wavelengths nearest the desired dominant wavelength and in packages that produce brightness levels consistent with other LEDs in the array may be substituted. Those LEDs or groups of LEDs may consequently have higher relative luminance values, depending upon the distance from the desired dominant wavelength and (if applicable) the distance to the nearest available dominant wavelength on the opposite side of the desired dominant wavelength.

CIE diagrams, CCT, alychne, McAdam ellipses and Planckian Locus are all concepts and terms well known to one of ordinary skill in the art and, thus, will not be further elaborated on herein. A reference providing further detail on colorimetry is Daniel Malacara, “Color Vision and Colorimetry Theory and Applications”, SPIE Press, 2002, the contents of which are incorporated herein by reference for all purposes.

An embodiment of a base-mix LED array according to the present invention may be formed of LEDs emitting at least five discrete dominant wavelengths and may include dominant wavelengths within the following ranges of visible light: red (630 to 670 nm), red-orange (600 to 630 nm), amber (585 to 600 nm), green (520 to 545 nm), cyan (495 to 520 nm), blue (460 to 495 nm) and royal blue (435 to 460 nm). Another embodiment of a base mix LED array may include 16 LEDS: one red LED, one red-orange LED, six amber LEDs, three green LEDs, two cyan LEDs, two blue LEDs and one royal blue LED of comparable brightness or power, arbitrarily arranged in a two-dimensional array. Of course, it will be apparent to one of ordinary skill in the art that various spatial combinations of the base mix LEDs may be formed into suitable arrays according to the present invention.

Table 1, below, is spatial representation of an embodiment of a base mix strip array in accordance with the present invention.

TABLE 1

| | | | | | | | |
|---|---|---|---|---|---|---|---|
| B | G | C | I | G | B | C | G |
| A | R | A | A | A | O | A | A |

The base mix strip array may include 16 LEDs spatially arranged as shown in Table 1, where B=blue, G=green, C=cyan, I=royal blue, A=amber and O=red-orange LEDS. A single unit formed of the 16 LEDs as shown in Table 1 may form a 2×8 micro-strip fixture according to an embodiment of base mix LED array. Each of the seven colors may be controlled by a separate circuit or by a single LED driver circuit with independent control of each LED according to other embodiments of a base mix LED array. According to a specific embodiment of base mix strip array, the LEDs may be mounted in rows within the channels on a finned extrusion, thereby providing adequate heat-dissipating surface area while leaving a flat surface exposed for wall-mounting or other surface mounting of the fixture. One such extrusion is part #XX5052 from Wakefield Thermal Solutions, Inc., 33 Bridge Street, Pelham, NH 03076. Of course, other suitable extrusions, custom-designed housing components, and mounting arrangements for the LEDs in a fixture that maintain the spatial arrangement of Table 1 are also contemplated within the scope of the present invention.

Further embodiments based on arrays of the base mix LED array and variants are also contemplated in the present invention. For example, an embodiment of a LED array according to the present invention may include a linear array of base mix strip arrays. The LED arrays may be stacked horizontally or vertically according to further embodiments of the present invention. For example, an embodiment of a 2×32 LED array may include 4 base mix strips stacked horizontally.

Table 2, below, illustrates a variation of the base mix strip array that may be referred to herein as a reverse base mix strip array.

TABLE 2

| | | | | | | | |
|---|---|---|---|---|---|---|---|
| A | A | O | A | A | A | R | A |
| G | C | B | G | I | C | G | B |

where
R = red,
O = red-orange,
A = amber,
G = green,
C = cyan,
B = blue and
I = royal blue.
Note that the reverse base mix array is the same as the base mix array rotated by 180°.

Further embodiments based on arrays of the reverse base mix strip array and variants are also contemplated in the present invention. For example, an embodiment of a LED array according to the present invention may include a linear array of reverse base mix strip arrays. The LED arrays may be stacked horizontally or vertically according to further embodiments of the present invention. Additionally, according to another embodiment, a 4×16 LED array may consist of two base mix strip arrays stacked horizontally with two reverse base mix strip arrays also stacked horizontally and then vertically underneath the two base mix strip arrays. Such a 4×16 LED array may produce a single, composite beam that is roughly equivalent to that produced by a PAR fixture.

Table 3, below, illustrates an embodiment of a 4×4 base mix array,

TABLE 3

| | | | |
|---|---|---|---|
| B | G | A | C |
| A | R | G | A |
| A | I | O | A |
| C | A | G | B |

where R=red, O=red-orange, A=amber, G=green, C=cyan, B blue and I=royal blue. The 4×4 base mix array comprises a nearly symmetrical design for a 4×4 special fixture. Each of the seven colors may be controlled by a separate circuit or by a single LED driver circuit with independent control of each LED according to other embodiments of a base mix LED array.

LEDs for the above-referenced LED arrays may be Luxeon™ LEDs, 1.2-Wait package of the specified color/wavelength. Luxeon™ LEDs are available from Lumileds Lighting, LLC, 370 West Trimble Road, San Jose, Calif., 95131.

A preferred embodiment includes all LEDs in the lambertian radiation pattern package with or without secondary, collimating optics. Dominant wavelengths for suitable LEDs according to the present invention may be approximately as follows: I=royal blue=455 nm, B=blue=470 nm, C=cyan=505 nm, G=green=530 nm, A=amber=590 nm, O=red-orange=617 nm and R=red=625 nm. Of course, any suitable source of LEDs consistent with embodiments of the present invention may also be used, including those with nearly the same colors but different approximate dominant wavelengths.

The LEDs may be mounted with thermally conductive adhesive onto the flat surface(s) of an aluminum extrusion with heat-dissipating fins, according to embodiments of the present invention.

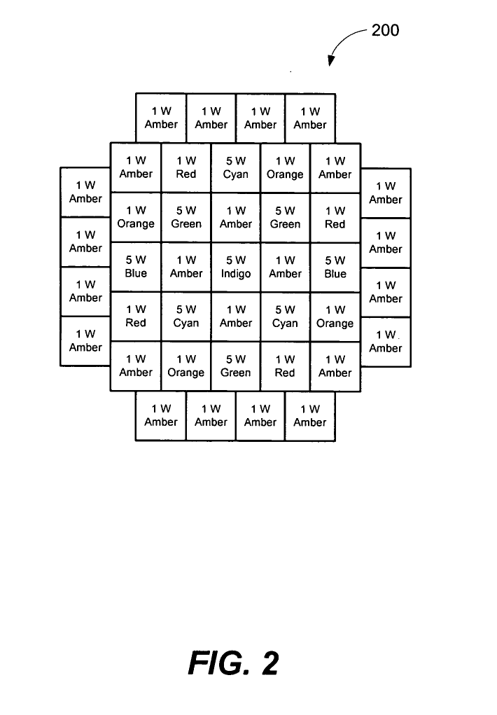

FIG. 2 illustrates another embodiment of a LED array 200 consistent with the present invention. According to an embodiment of LED array 200, the individual LEDs may be Luxeon by Lumileds, emitter package, lambertian radiation pattern, and either 1.2-Watt or 5-Watt package depending on the individual LED color as indicated in FIG. 2. LED array 200 may be configured as an ultra-high-density fixture fitting within an approximately 2.5×2.5 square inch area. LED array 200 may include secondary optics to mix and subsequently focus the light from the whole array of individual LEDs into a single, shaped, sharp-edged beam according to an embodiment of the present invention. Another embodiment of LED array 200 may include a light-pipe design attached to additional collimating lenses. The seven colors may be controlled with the same or similar controller circuitry as used for the above-described fixtures, i.e., the seven colors or individual LEDs may be dimmed separately according to other embodiments of the present invention.

An embodiment of a LED array may be formed of a plurality of LEDs, each LED or group of identically colored LEDs comprising a dominant wavelength within the visible spectrum (400 to 750 nm) having overall luminance sufficient to illuminate an object from a distance of at least 24 inches. Another embodiment of a LED array may be configured with each LED or group of identically colored LEDs within the LED array for independent control.

According to another embodiment of a LED array according to the present invention, each LED or group of identically colored LEDs may produce colored light with a predefined spectral half-width, for example less than about 60 nm, or less than about 40 nm, or less than about 30 nm. Of course these are only exemplary spectral half-widths and other spectral half-widths consistent with the present invention are also considered within the scope of the present invention.

Yet another embodiment of a LED array may include a plurality of LEDs comprising at least the following specified colors and within 25 nm of an associated dominant wavelength: violet 425 nm, blue 465 nm, cyan 500 nm, green 530 nm, lime 555 nm, amber 580 nm, orange 610 nm and red 650 nm. Other embodiments consistent with the present invention may include associated dominant wavelengths within 15 nm or even 5 nm of the specified colors and dominant wavelengths.

Yet another embodiment of a LED array according to the present invention may include a plurality of LEDs comprising at least the following specified colors and within 25 nm of an associated dominant wavelength: violet 405 nm, indigo 445 nm, blue 480 nm, cyan 510 nm, green 535 nm, lime 555 nm, yellow-amber 575 nm, orange 600 nm, orange-red 630 nm and deep red 665 nm. Other embodiments of a LED array consistent with the present invention may further include associated dominant wavelengths within 15 nm or even within 5 nm of the specified colors and dominant wavelengths.

Still another embodiment of a LED array according to the present invention may include the plurality of LEDs comprising at least the following specified colors and within 25 nm of an associated dominant wavelength: violet 410 nm, indigo 445 nm, blue 475 nm, cyan 500 nm, aqua 520 nm, green 540 nm, lime 555 nm, yellow 570 nm, amber 590 nm, orange 610 nm, red-orange 635 nm and deep red 665 nm. Other embodiments may further include associated dominant wavelengths within 15 nm or even 5 nm of the specified colors and dominant wavelengths. Of course, the proximity of the associated dominant wavelengths may be arbitrarily selected within the range of 5 nm to 25 nm, consistent with the present invention. The above described embodiments are merely exemplary.

Another embodiment of a LED array according to the present invention may include having each dominant wavelength separated from its nearest neighbor on either side by not more than a predefined separation distance. Any predefined distance with the range from about 10 nm to about 50 nm is consistent with embodiments of the present invention. For example and not by way of limitation, 20 nm, 30 nm and 40 nm are embodiments of a predefined separation distance consistent with the present invention. According to yet another embodiment the separation between the dominant wavelengths may gradually increases away from either side of approximately 555 nm. Yet another embodiment of a LED array according to the present invention may further include LEDs with a dominant wavelength in the near-ultra-violet region defined from about 300 nm to about 400 nm.

Yet further embodiments of a LED array according to the present invention may include a plurality of LEDs numbering less than or equal to a predetermined number of LEDs. For example and not by way of limitation the predetermined number of LEDs may be 100, 64, 36 or 16 LEDs according to embodiments of the present invention. In further embodiments of a LED array according to the present invention may further include each of the plurality of LEDs comprising a predetermined power rating for example and not by way of limitation, the predetermined power rating may be at least 0.25, 0.5, or 1.0 Watts of power at full brightness according to embodiments of the present invention.

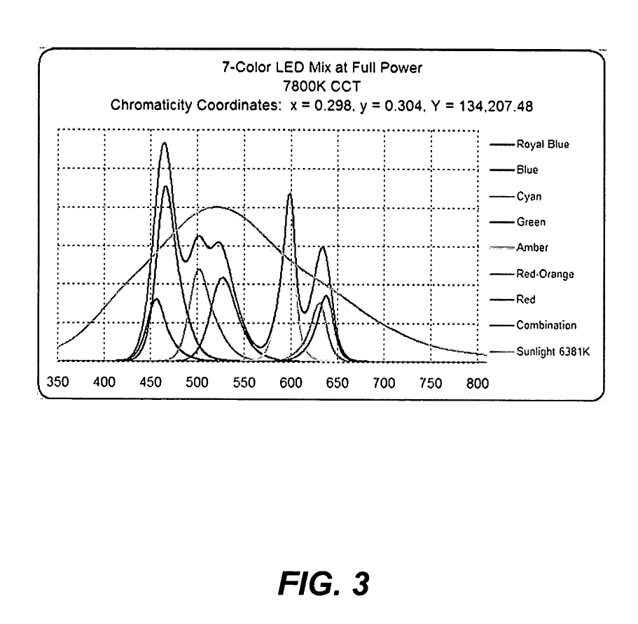

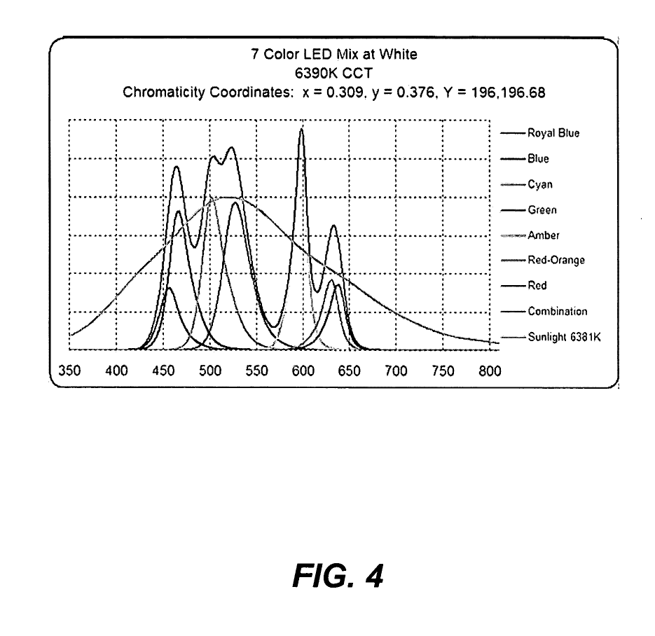

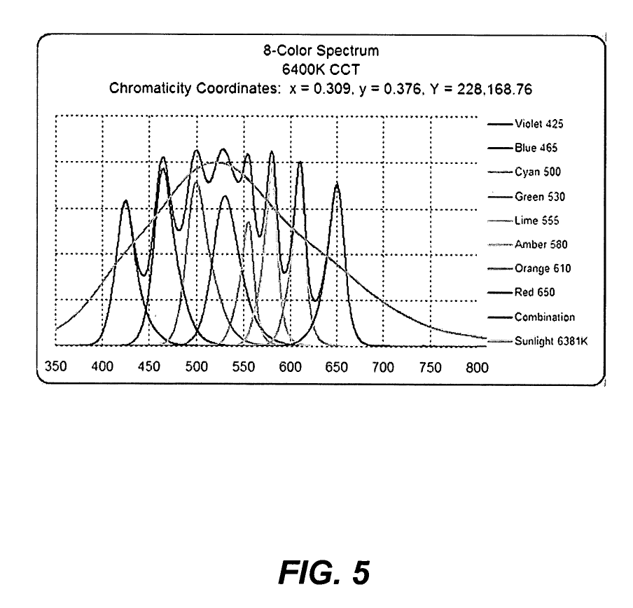

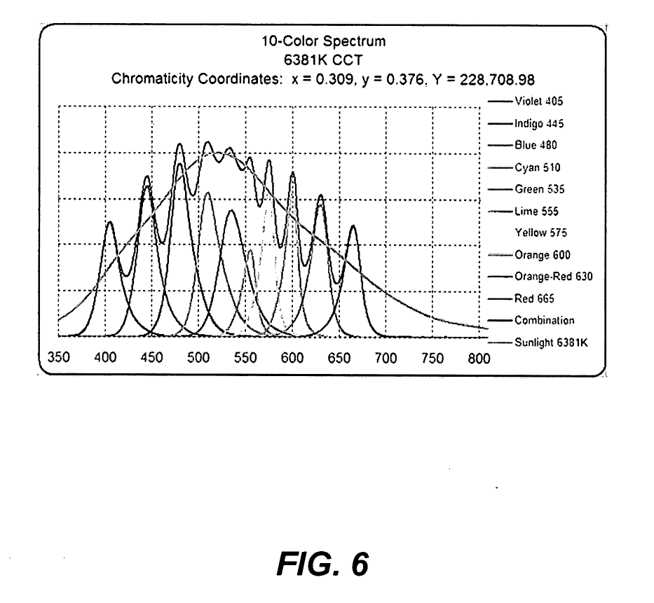

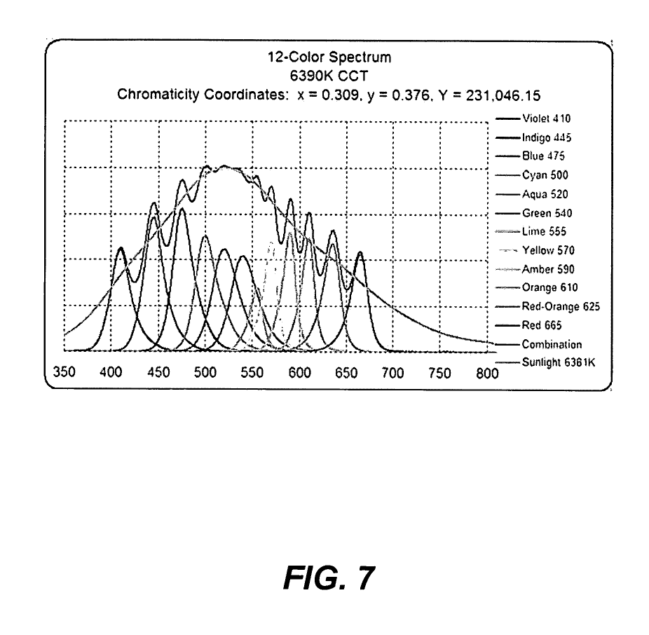

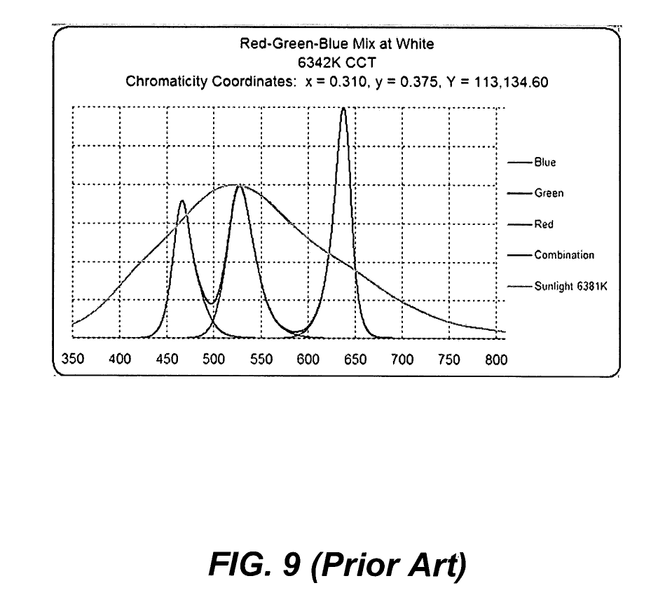

FIG. 3 is a graph of the spectrum of a 7-Color LED array at full power in accordance with an embodiment of the present invention. FIG. 4 is a graph of the spectrum of a 7-Color LED array at white in accordance with an embodiment of the present invention. FIG. 5 is a graph of the spectrum of an 8-Color LED array in accordance with an embodiment of the present invention. FIG. 6 is a graph of the spectrum of a 10-Color LED array in accordance with an embodiment of the present invention. FIG. 7 is a graph of the spectrum of a 12-Color LED array in accordance with an embodiment of the present invention. FIG. 9 is a graph of the spectrum of a conventional RGB LED array.

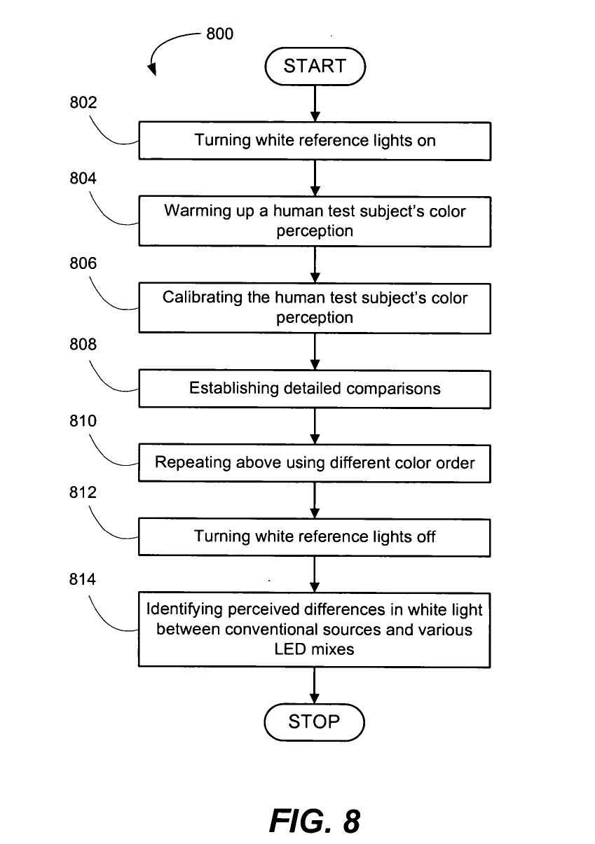

FIG. 8 is a flow chart of a method 800 for determining human color perception in accordance with the present invention. Method 800 for determining human color perception may be synonymously referred to herein as a “test”. The purpose of this test is to determine a suitable design for additive color mixing within the proposed LED-based lighting fixture. Method 800 may include turning on 802 white reference lights, warming up 804 a human test subject's color perception and calibrating 806 the human test subject's color perception. Method 800 may further include establishing 808 detailed comparisons and repeating above 810 using different color order. Method 800 may further include turning off 812 white reference lights and identifying 814 perceived differences in white light between conventional sources and various LED mixes.

A test fixture may be used in conjunction with method 800 according to an embodiment of the present invention. The test fixture may include three windows set side by side on a black panel. Behind each window is an array of ten groups of LEDs at various dominant wavelengths. Each window may also include a halogen lamp that can be filtered, as well as other sources, such as fluorescent bulbs according to embodiments of the present invention. Between these big windows are two smaller windows, behind which are halogen lamps that serve as a constant white reference during color testing—allowing test subjects to keep their eyes refreshed.

The ten dominant wavelengths of LEDs in the test fixture include: red (660 nm), orange-red (625 nm), orange (605 nm), amber (590 nm), lime-yellow (565 nm), green (530 nm), cyan (510 nm), blue (475 nm), indigo (450 nm) and blue-violet (420 nm). These colors may be spaced approximately even across most of the visible spectrum. Six of the colors (orange-red, amber, green, cyan, blue, indigo) are obtained from single, 1.2 Watt LEDs (Luxeon™ LEDs by Lumileds). The other four colors are produced by LEDs in the standard 5-mm package that is often used in smaller or older LED fixtures. Consequently, for these smaller LEDs, up to fifty LEDs of a single color were required to achieve comparable brightness levels between all ten colors.

Method 800 is portable and may be administered to various kinds of individuals, including lighting professionals in their own work locations as well as the general population in public settings, e.g., malls, museums and the like. According to an embodiment of the method 800, the test subject sits at a table with a test administrator. For some portions of method 800 the white reference lights will be on. During other portions of the method 800 the white reference lights will be off (see the specific embodiment of method 800 below).

There are a number of factors that may bias the responses during the test. For example, sensitivity to perceived differences in color will likely change as the test progresses. Colors are relative-what looks lime green next to a red light might look orange next to a cyan light. Colors in isolation may appear more or less saturated than when they are viewed next to other colors. Ambient lighting in the testing location may affect color perception. The way a color is remembered may be different than what was actually viewed. Physiological and demographic factors may influence the precision with which a subject perceives color. Minimizing such biasing factors may increase the accuracy of the test results.

The following is an exemplary test scenario in accordance with embodiments of method 800. The exemplary test scenario was applied to approximately seventy human test subjects ranging in age from fifteen to sixty-five years old. The human test subjects included lighting professionals as well as average consumers. The human test subjects were asked to provide quantitative ratings of color mixes in three, different test sections comprising Tests I-II.

The following definitions apply to the exemplary test scenario as described herein. “RGB” refers to a mix of red, green, and blue LEDs only—comparable to LED fixtures already on the market. “High-Brightness” refers to a mix of Luxeon™ brand LEDs, i.e., those used in the test fixture described above and limited in colors to orange-red, amber, green, cyan, blue, and indigo. “All Ten Colors” refers to the combination of red, orange-red, orange, amber, lime-yellow, green, cyan, blue, indigo and blue-violet. “Single Color” refers to one of red, orange-red, orange, amber, lime-yellow, green, cyan, blue, indigo and blue-violet.

In Test I human test subjects viewed one test color at a time, comprised of either a single color of LED or a combination of multiple LEDs, i.e., colors made from RGB, the High-Brightness mix, and All Ten Colors. The human test subjects were asked to indicate the perceived saturation of the color according to the following scale: 0=very pale, 1=quite pale, 2=slightly pale, 3=moderately saturated, 4=quite saturated and 5=as deeply saturated as is possible.

The results of Test I of the exemplary test scenario are contained in the Table 4—Saturation Level, below. Table 4 includes a column showing the name of the test color, the light source used to produce the color, and the average saturation rating received for each color and source. The test colors of red, green, and blue were omitted, since for all possible combinations—RGB, High-Brightness and All Ten Colors—the same LED colors would have been used. The light source with the highest average score (saturation) is shown for each color in bold.

TABLE 4
SATURATION LEVEL

| COLOR NAME | LIGHT SOURCE | AVERAGE SCORE |
|---|---|---|
| Red-Orange | Single Color | 3.8 |
| Red-Orange | RGB | 3.2 |
| Orange | Single Color | 3.8 |
| Orange | High-Brightness | 3.3 |
| Amber | Single Color | 2.9 |
| Amber | RGB | 2.4 |
| Yellow | High-Brightness | 2.8 |
| Yellow | All Colors | 2.1 |
| Yellow | RGB | 1.6 |
| Lime | Single Color | 2.8 |
| Lime | RGB | 2.8 |
| Lime | High-Brightness | 2.6 |
| Cyan | Single Color | 3.7 |
| Cyan | RGB | 2.6 |
| Indigo (bright) | Single Color | 4.6 |
| Indigo (bright) | RGB | 2.8 |
| Indigo (dim) | Single Color | 4.0 |
| Indigo (dim) | RGB | 3.3 |
| Violet | High-Brightness | 3.7 |
| Violet | RGB | 2.7 |
| Magenta | High-Brightness | 4.3 |
| Magenta | RGB | 3.0 |
| Purple | High-Brightness | 3.6 |
| Purple | RGB | 2.4 |

In Test II human test subjects viewed two similar test colors comprised of different combinations of LEDs, e.g., the amber LED alone compared with a mix of red and green LEDs that approximated the appearance of the amber as closely as possible. The human test subjects were asked to first identify the more saturated color of the two, then rate the difference between the two saturation levels according to the following scale: 0=too different to be related, 1=related but very different, 2=obvious difference, 3=perceptible difference, 4=barely perceptible difference and 5=no difference.

Table 5 shows the results of Test II, with the name of the test color in the left column, followed by the two color combinations used to achieve the test color and their respective numbers of votes for being the more saturated combination. The votes did not always total the same number as some of the human test subjects were unable to perceive a difference in saturation for particular colors. The right column shows the average difference perceived between the two versions of each test color. The light sources having the highest perceived saturation are shown in bold in Table 5.

TABLE 5

| | Which light source is more saturated? | | | | AVERAGE |
|---|---|---|---|---|---|
| COLOR | | VOTES | | | DIFFERENCE |
| Red- | Single | 34 | 22 | RGB | 2.6 |
| Orange | | | | | |
| Orange | High-Brightness | 9 | 47 | Single | 3.1 |
| Orange | RGB | 15 | 40 | Single | 1.4 |
| Amber | RGB | 22 | 34 | Single | 1.3 |
| Yellow | All Colors | 10 | 47 | Lime + Amber | 3.1 |
| Yellow | Lime + Amber | 16 | 40 | RGB | 1.6 |
| Yellow | High-Brightness | 8 | 45 | Lime + Amber | 3.8 |
| Lime | Single | 51 | 4 | High- | 3.6 |
| | | | | Brightness | |
| Lime | RGB | 40 | 15 | Single | 3.1 |
| Cyan | Single | 49 | 5 | RGB | 2.8 |
| Indigo | Single (bright) | 14 | 41 | Single (dim) | 3.2 |
| Indigo | Single | 52 | 1 | RGB | 2.8 |
| Violet | Single | 2 | 54 | High- | 3.4 |
| | | | | Brightness | |
| Violet | Single | 42 | 12 | RGB | 2.3 |
| Purple | High-Brightness | 47 | 8 | RGB | 1.7 |
| Purple | RGB | 6 | 48 | High- | 1.0 |
| | | | | Brightness | |
| Purple | High-Brightness | 49 | 7 | RGB | 0.7 |
| Magenta | High-Brightness | 50 | 5 | RGB | 1.1 |
| Magenta | RGB | 5 | 52 | High- | 1.6 |
| | | | | Brightness | |
| Magenta | High-Brightness | 51 | 3 | RGB | 2.5 |

The test results in Table 5 suggest that for most test colors the RGB mix appeared less saturated than the High-Brightness mix, All Colors mix and single LEDs, especially at yellow, amber, indigo and magenta. The six-LED, High-Brightness mix consistently appeared more saturated than RGB, as did the All Colors mix of all ten LED colors. The only exception was for a lime-yellow color, where RGB was rated slightly more saturated than the High-Brightness mix. Some mixes of multiple LEDs, at colors such as red-orange, appeared more saturated than single LEDs of the same apparent color, perhaps because they seemed more natural-looking, perhaps because it is rare in nature to see a color like red-orange that does not also include some deep red, orange, and amber components.

In Test III the human test subjects viewed a mix of LEDs that approximated white as closely as possible at one of three correlated color temperatures. They viewed mixes of white light at roughly 7,400 K (cool white), 5,600 K (medium white), and 3,800 K (warm white) and comprised of either RGB, a High-Brightness mix (six colors), or an All Colors mix of all ten LED colors. The human test subjects were asked to rate the perceived whiteness of the mix according to the following scale: 0=too colored or gray to be called white, 1=white, but obviously colored or gray, 2=white, but slightly colored or gray, 3=as white as normal indoor lighting, 4=as white as midday sunlight and 5=whiter than midday sunlight.

The test results in Table 6 for Test III shows the correlated color temperature in the left column, the color combination used to produce white light at that temperature in the center column, and the average perceived whiteness of each test mix in the right column.

TABLE 6
Whiteness

| CORRELATED COLOR | | |
|---|---|---|
| TEMPERATURE | LIGHT SOURCE | AVERAGE |
| Warm White | All Colors | 1.5 |
| (3,800 K) | RGB | 0.8 |
| | High-Brightness | 2.2 |
| Medium White | High-Brightness | 3.8 |
| (5,600 K) | RGB | 0.9 |
| | All Colors | 2.3 |
| Cool White | RGB | 0.7 |
| (7,400 K) | All Colors | 2.0 |
| | High-Brightness | 4.4 |

The results for the whiteness test shown in Table 6 suggest that the High-Brightness LED mix appeared whiter than both the RGB mix and the All Colors mix of all ten colors at all correlated color temperatures. The highest-rated white was the high-brightness mix at 7400 degrees Kelvin.

There were many factors that might have influenced the performance of the test and partially skewed the results. The intensity and quality of ambient light in the test environment, the speed at which the test was conducted, the distance from the test device at which the observers sat, the ambient temperature (which can very slightly alter the color produced by LEDs) and the order in which the different tests were administered, among many other factors, might have affected the perceived quality of light produced by each color mix. Additionally, it is acknowledged that the exemplary test results above are not a completely clinical examination of human color perception. However, these limited results suggest that the current approaches to additive color mixing in LED fixtures, namely RGB and RGBA, are not producing light of the highest possible quality and that lighting professionals and others would benefit from fixtures incorporating a more inclusive or comprehensive mix of LED colors.

The exemplary test results suggest four conclusions: (1) the composition of LED colors used in an array can have a profound impact on apparent color mixing capabilities, (2) average observers perceive major differences between white light made of many discrete colors and that made of only a few, (3) the best color production appears to be from arrays made with the most possible colors of LEDs, and (4) the best white light appears to be that which contains the most wavelengths across the spectrum.

A presently preferred embodiment of a color mix for a LED array consistent with the present invention may include seven colors of LEDs in ultra-high-brightness packages—the six high-brightness colors used for testing and an additional high-brightness red LED. However, as the availability of additional high brightness LEDs covering additional portions of the visible spectrum increases, other preferred embodiments will become apparent. The ideal embodiment of a LED array of the present invention includes any suitable number of high-brightness, color LEDs sufficiently covering the visible spectrum to allow the user to accurately reproduce any desired dominant wavelength at any desired level of saturation and at a relative luminance level that is consistent with the distribution of spectral power in midday sunlight (at approximately 6500K.) The LED arrays, lighting fixtures and systems of the present invention appear to be superior to conventional lighting systems for reproducing visible light for a number of reasons including: the inventive lighting embodiments can produce more deeply saturated colors across the entire visible spectrum, generate richer whites with a greater range of realistic correlated color temperatures, generate fuller soft colors that are more appealing and more natural-looking especially on skin tones, illuminate colored objects in a manner more similar to midday sunlight or other conventional white-light sources, and provide well balanced color mixing with intuitive intensity levels at all colors.

While the foregoing advantages of the present invention are manifested in the illustrated embodiments of the invention, a variety of changes can be made to the configuration, design and construction of the invention to achieve those advantages. For example, while LEDs are the exemplary colored light source described herein, other sources of colored light may be used, e.g., lasers or a LED covered with a narrowband-emitting phosphor or other down-converting medium that is capable of high brightness in dominant wavelengths. Furthermore, other light source technologies, e.g., electroluminescence, electrophoretic display, electrochromic display, electrowetting, gas plasma and fiber plasma, may also be suitable as equivalents for the LEDs described herein to the extent such other light source technologies have the brightness and spectral distribution characteristics described and claimed herein. Hence, reference herein to specific details of the structure and function of the present invention is by way of example only and not by way of limitation.

What is claimed is:

1. An LED array formed of a plurality of LEDs, each LED or group of identically colored LEDs comprising a dominant wavelength within the visible spectrum (400 to 750 nm) having overall luminance sufficient to illuminate an object from a distance of at least 24 inches.

2. The LED array according to claim 1, wherein each LED or group of identically colored LEDs within the LED array is configured for independent control.

3. The LED array according to claim 1, wherein each LED or group of identically colored LEDs produces colored light with a spectral half-width of less than about 60 nm.

4. The LED array according to claim 1, wherein each LED or group of identically colored LEDs produces colored light with a spectral half-width of less than about 40 nm.

5. The LED array according to claim 1, wherein each LED or group of identically colored LEDs produces colored light with a spectral half-width of less than about 30 nm.

6. The LED array according to claim 1, wherein the plurality of LEDs comprises at least the following specified colors and within 25 nm of an associated dominant wavelength: violet 425 nm, blue 465 nm, cyan 500 nm, green 530 nm, lime 555 nm, amber 580 nm, orange 610 nm and red 650 nm.

7. The LED array according to claim 6, wherein the plurality of LEDs further comprise associated dominant wavelengths within 15 nm of the specified colors and dominant wavelengths.

8. The LED array according to claim 6, wherein the plurality of LEDs further comprise associated dominant wavelengths within 5 nm of the specified colors and dominant wavelengths.

9. The LED array according to claim 1, wherein the plurality of LEDs comprises at least the following specified colors and within 25 nm of an associated dominant wavelength: violet 405 nm, indigo 445 nm, blue 480 nm, cyan 510 nm, green 535 nm, lime 555 nm, yellow-amber 575 nm, orange 600 nm, orange-red 630 nm and deep red 665 nm.

10. The LED array according to claim 9, wherein the plurality of LEDs further comprise associated dominant wavelengths within 15 nm of the specified colors and dominant wavelengths.

11. The LED array according to claim 9, wherein the plurality of LEDs further comprise associated dominant wavelengths within 5 nm of the specified colors and dominant wavelengths.

12. The LED array according to claim 1, wherein the plurality of LEDs comprises at least the following specified colors and within 25 nm of an associated dominant wavelength: violet 410 nm, indigo 445 nm, blue 475 nm, cyan 500 nm, aqua 520 nm, green 540 nm, lime 555 nm, yellow 570 nm, amber 590 nm, orange 610 nm, red-orange 635 nm and deep red 665 nm.

13. The LED array according to claim 12, wherein the plurality of LEDs further comprise associated dominant wavelengths within 15 nm of the specified colors and dominant wavelengths.

14. The LED array according to claim 12, wherein the plurality of LEDs further comprise associated dominant wavelengths within 5 nm of the specified colors and dominant wavelengths.

15. The LED array according to claim 1, wherein each dominant wavelength is separated from its nearest neighbor on either side by not more than about 40 nm.

16. The LED array according to claim 1, wherein each dominant wavelength is separated from its nearest neighbor on either side by not more than about 30 nm.

17. The LED array according to claim 1, wherein each dominant wavelength is separated from its nearest neighbor on either side by not more than about 20 nm.

18. The LED array according to claim 1, wherein separation between the dominant wavelengths gradually increases away from either side of approximately 555 nm.

19. The LED array according to claim 1, further comprising LEDs with a dominant wavelength in the near-ultra-violet region defined from about 300 nm to about 400 nm.

20. The LED array according to claim 1, wherein the plurality of LEDs number less than or equal to 100 LEDs.

21. The LED array according to claim 1, wherein the plurality of LEDs number less than or equal to 64 LEDs.

22. The LED array according to claim 1, wherein the plurality of LEDs number less than or equal to 36 LEDs.

23. The LED array according to claim 1, wherein the plurality of LEDs number less than or equal to 16 LEDs.

24. The LED array according to claim 1, wherein each of the plurality of LEDs comprises at least 0.25 Watts of power at full brightness.

25. The LED array according to claim 1, wherein each of the plurality of LEDs comprises at least 0.5 Watts of power at full brightness.

26. The LED array according to claim 1, wherein each of the plurality of LEDs comprises at least 1.0 Watts of power at full brightness.

27. The LED array according to claim 1, wherein an area enclosed by plotting an output of each LED on a CIE Chromaticity diagram as a point and connecting the points covers at least 75% of the total area defined within the curve of spectrally pure colors and an alychne of purple colors.

28. The LED array according to claim 1, wherein an area enclosed by plotting an output of each LED on a CIE Chromaticity diagram as a point and connecting the points covers at least 85% of the total area defined within the curve of spectrally pure colors and an alychne of purple colors.

29. The LED array according to claim 1, wherein an area enclosed by plotting an output of each LED on a CIE Chromaticity diagram as a point and connecting the points covers at least 95% of the total area defined within the curve of spectrally pure colors and an alychne of purple colors.

30. The LED array according to claim 1, wherein relative luminance values for all LEDs within the LED array operating at full brightness levels results in a composite white-type light that may be plotted on a CIE Chromaticity diagram within McAdam ellipses that are on or adjacent to a Planckian Locus within a predefined correlated color temperature (CCT) range.

31. The LED array according to claim 30, wherein the predefined CCT range comprises between about 1500° K and about 25,000° K.

32. The LED array according to claim 30, wherein the predefined CCT range comprises between about 3000° K and about 10,000° K.

33. The LED array according to claim 30, wherein the predefined CCT range comprises between about 4500° K and about 7500° K.

34. The LED array according to claim 30, wherein the predefined CCT range comprises between about 5500° K and about 6500° K.

35. The LED array according to claim 1, wherein relative luminance of each LED or group of LEDs in the LED array comprises a spectral power distribution within 30% normalized mean deviation of a spectral power distribution of midday sunlight having correlated color temperature (CCT) of about 6500° K.

36. The LED array comprising Luxeon™ LEDs in a base mix of one red LED, one red-orange LED, six amber LEDs, three green LEDs, two cyan LEDs, two blue LEDs and one royal blue LED.

37. The LED array according to claim 36, wherein the LED array comprises a 2×8 base mix strip array configured as:

| | | | | | | | |
|---|---|---|---|---|---|---|---|
| B | G | C | I | G | B | C | G |
| A | R | A | A | A | O | A | A |

where
R = red,
O = red-orange,
A = amber,
G = green,
C = cyan,
B = blue and
I = royal blue.

38. The LED array according to claim 37 wherein the dominant wavelengths of the LEDs are within 15 nm of the following: I=royal blue=455 nm, B=blue=470 nm, C=cyan=505 nm, G=green=530 nm, A=amber=590 nm, 0=red-orange=617 nm and R=red=625 nm.

39. An array of base mix strip arrays according to claim 36.

40. A linear array of base mix strip arrays according to claim 36, wherein the base mix strip arrays are stacked vertically or horizontally.

41. The LED array according to claim 36, wherein the LED array comprises a 2×8 reverse base mix strip array configured as:

| | | | | | | | |
|---|---|---|---|---|---|---|---|
| A | A | O | A | A | A | R | A |
| G | C | B | G | I | C | G | B |

where
R = red,
O = red-orange,
A = amber,
G = green,
C = cyan,
B = blue and
I = royal blue.

42. An array of reverse base mix strip arrays according to claim 41.

43. A linear array of reverse base mix strip arrays, according to claim 41, wherein the reverse base mix strip arrays are stacked vertically or horizontally.

44. The LED array according to claim 36, wherein the LED array comprises a 4×4 base mix array configured as:

| | | | |
|---|---|---|---|
| B | G | A | C |
| A | R | G | A |
| A | I | O | A |
| C | A | G | B |

where
R = red,
O = red-orange,
A = amber,
G = green,
C = cyan,
B = blue and
I = royal blue.

45. An LED lighting system, comprising:
a power supply;
an LED-array formed of a plurality of LEDs emitting at least the following discrete wavelengths of visible light: red, red-orange, amber, green, cyan, blue and royal blue; and
a controller in communication with the power supply and the LED array for selectively varying the intensity of light emitted by the LEDs.

46. A method of testing human visual perception comprising:
turning white reference lights on;
warming up a human test subject's color perception;
calibrating the human test subject's color perception;
establishing detailed comparisons;
repeating above using different color order;
turning white reference lights off; and
identifying perceived differences in white light between conventional sources and various LED mixes.

47. The method according to claim 46, wherein establishing detailed comparisons comprises:
quantifying perceived differences between color mixes;
comparing various LED mixes with filtered, full-spectrum conventional light sources; and
establishing an optimal mix of LED colors within an array.
